(19) United States
(12) Patent Application Publication
(10) Pub. No.: US 2026/0112211 A1
(43) Pub. Date: Apr. 23, 2026

(54) VEHICLE EMISSIONS GEOGRAPHICAL OPTIMIZER

(71) Applicant: Toyota Research Institute, Inc., Los Altos, CA (US)

(72) Inventors: Rumen Iliev, Millbrae, CA (US); Chi Zhang, Palo Alto, CA (US); Vijay Thamalla, Arlington, TX (US)

(73) Assignees: Toyota Research Institute, Inc., Los Altos, CA (US); Toyota Jidosha Kabushiki Kaisha, Toyota-shi (JP)

(21) Appl. No.: 18/920,091

(22) Filed: Oct. 18, 2024

(51) Int. Cl. G07C 5/00; G07C 5/08

(52) U.S. Cl. CPC G07C 5/008; G07C 5/0808

(57) ABSTRACT

Systems and methods described herein relate to evaluating sensor data from a first vehicle to determine a vehicle template corresponding to a second vehicle, obtaining a set of emissions-related data from sensors of the first vehicle, recording a first subset of emissions-related data to a vehicle record corresponding to the second vehicle based on the vehicle template, and recording a second subset of emissions-related data to a geographical record based on a location of the first vehicle.

### TECHNICAL FIELD

The subject matter described herein relates, in general, to strategies for analyzing vehicle emissions in order to minimize environmental impact.

### BACKGROUND

In many parts of the world, environmental regulators are interested in minimizing the environmental impact of vehicles. For example, battery electric vehicles (“BEVs”) are seen as potentially being able to achieve complete decarbonization of light-duty vehicle transportation, even if currently we do not have the manufacturing capabilities or the charging infrastructure to switch over completely to BEVs at this time. As such, in the near future, a mix of internal combustion engine vehicles (“ICEVs”), hybrid electric vehicles (“HEVs”), Plug-in Hybrid Electrical Vehicles (“PHEVs”) and BEVs can be expected to constitute the make-up of light-duty vehicle transportation, where each category of vehicles may have different environmental impacts within an area of interest. For example, the environmental impact of BEVs depends on the carbon cost of the electricity being produced. Accordingly, in Vermont where about 99% of the generated electricity is based on renewable sources the use of BEVs may yield a very low carbon cost, while in West Virginia where the percentage is about 5% the use of BEVs may yield a much higher carbon cost. Furthermore, altitude, terrain, climate and other additional factors between different areas of interest may cause different emissions among or between various vehicle configurations.

### SUMMARY

In one embodiment, a vehicle management system is disclosed. The vehicle management system includes one or more processors and a memory communicably coupled to the one or more processors. The memory stores a command module including instructions that when executed by the one or more processors cause the one or more processors to evaluate sensor data from a first vehicle to determine a vehicle template corresponding to a second vehicle, obtain a set of emissions-related data from sensors of the first vehicle, record a first subset of emissions-related data to a vehicle record corresponding to the second vehicle based on the vehicle template, and record a second subset of emissions-related data to a geographical record based on a location of the first vehicle.

In one embodiment, a non-transitory computer-readable medium including instructions that when executed by one or more processors cause the one or more processors to evaluate sensor data from a first vehicle to determine a vehicle template corresponding to a second vehicle, obtain a set of emissions-related data from sensors of the first vehicle, record a first subset of emissions-related data to a vehicle record corresponding to the second vehicle based on the vehicle template, and record a second subset of emissions-related data to a geographical record based on a location of the first vehicle.

In one embodiment, a method is disclosed. In one embodiment, the method includes evaluating sensor data from a first vehicle to determine a vehicle template corresponding to a second vehicle, obtaining a set of emissions-related data from sensors of the first vehicle, recording a first subset of emissions-related data to a vehicle record corresponding to the second vehicle based on the vehicle template, and recording a second subset of emissions-related data to a geographical record based on a location of the first vehicle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a vehicle within which systems and methods disclosed herein may be implemented.

FIG. 2 illustrates one embodiment of a vehicular environmental analysis system that is associated with emissions analysis strategies.

FIG. 3 illustrates one embodiment of a cloud computing environment within which the systems and methods described herein may operate.

FIG. 4 illustrates one example of an environmental analysis database.

FIGS. 5A-C illustrates examples of emissions-related data gathering by a vehicle.

FIG. 6 illustrates one example of a method for emissions analysis strategies.

### DETAILED DESCRIPTION

Systems, methods, and other embodiments associated with estimating vehicle emissions in order to minimize environmental impact are described herein. Environmental analysis often relies on generalizations regarding vehicle emissions as non-point sources, which can obscure the impact that different vehicle mixes of ICEVs, HEVs, PHEVs, and BEVs may have with respect to a specific area. For example, altitude, terrain, and climate may all affect the climate impact arising from each category of vehicles. In addition, actual usage of a road for the various types of road users may differ from generalized expectations (e.g., climate impacts arising from a limited-access road designed for high-speed transit may differ considerably from a local collector serving an industrial area), such that generalized environmental data may be insufficient to estimate localized environmental impacts. For example, in order to address concerns about the environmental impact of vehicular activities on low-income households bordering industrial areas, localized environmental data regarding diesel emissions may be required. In addition, given that the production of energy, fuel, and vehicle components may also contribute to a vehicle's environmental impact, analysis of those aspects may also need to be included to develop a full picture of localized environmental impact (e.g., how will an increase in BEV production be likely to cause an increase in natural gas emissions? If such an increase occurs, how will or should it be distributed locally?).

In order to address the above needs and others, the availability of vehicles to gather environmental data about their own operation or the operation of other vehicles may play an important role. For example, vehicles may use sensor data regarding their own performance (e.g., fuel/energy consumption, odometer data, speed, acceleration/braking, exhaust data) to estimate their vehicle emissions. In addition, vehicles may also use sensor data to obtain data regarding other vehicles to assess their environmental impact. For example, a car may use camera sensors to identify a pick-up truck, retrieve information about the pick-up truck (e.g., emissions template), and then use that information in combination with observations of the pick-up truck (e.g., speed, altitude, environmental factors, and so on) to estimate a climate impact of the pick-up truck as it travels. For example, a machine learning model may utilize information about the pick-up truck (e.g., weight, engine configuration, fuel requirements, hybrid battery size) and the additional sensor-based data information from the car to form emissions estimate for the pick-up truck.

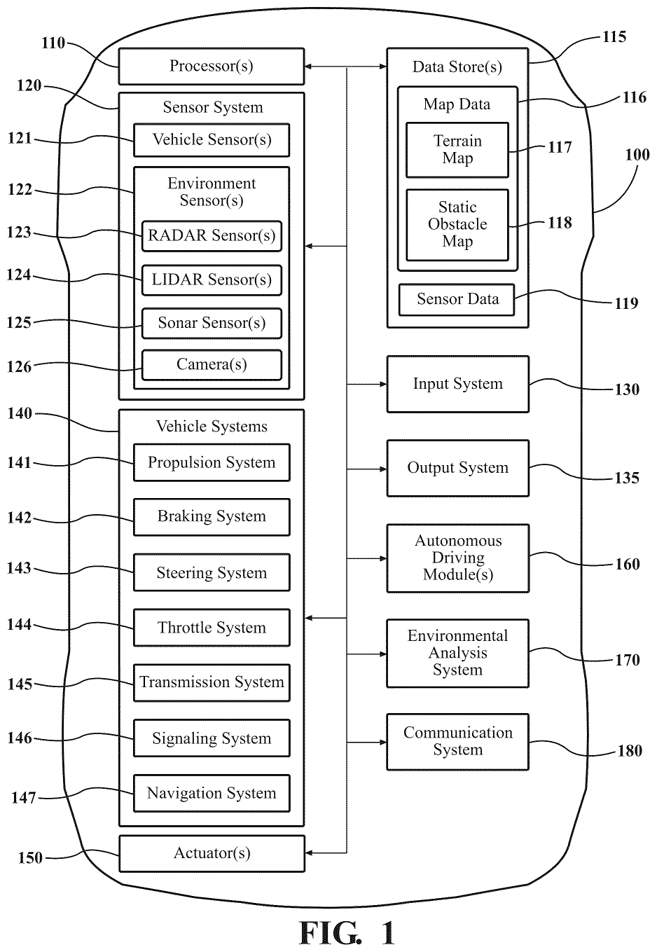

Referring to FIG. 1, an example of a vehicle 100 is illustrated. As used herein, a “vehicle” is any form of motorized transport. In one or more implementations, vehicle 100 is an automobile. While arrangements will be described herein with respect to automobiles, it will be understood that embodiments are not limited to automobiles. In some implementations, vehicle 100 may be any robotic device or form of motorized transport that, for example, includes sensors to perceive aspects of the surrounding environment, and thus benefits from the functionality discussed herein associated with emissions analysis strategies. As a further note, this disclosure generally discusses vehicle 100 as traveling on a roadway with surrounding vehicles, which are intended to be construed in a similar manner as vehicle 100 itself. That is, the surrounding vehicles may include any vehicle that may be encountered on a roadway by vehicle 100.

Vehicle 100 also includes various elements. It will be understood that in various embodiments it may not be necessary for vehicle 100 to have all of the elements shown in FIG. 1. Vehicle 100 may have any combination of the various elements shown in FIG. 1. Further, vehicle 100 may have additional elements to those shown in FIG. 1. In some arrangements, vehicle 100 may be implemented without one or more of the elements shown in FIG. 1. While the various elements are shown as being located within vehicle 100 in FIG. 1, it will be understood that one or more of these elements may be located external to vehicle 100. Further, the elements shown may be physically separated by large distances. For example, as discussed, one or more components of the disclosed system may be implemented within a vehicle while further components of the system are implemented within a cloud-computing environment or other system that is remote from vehicle 100.

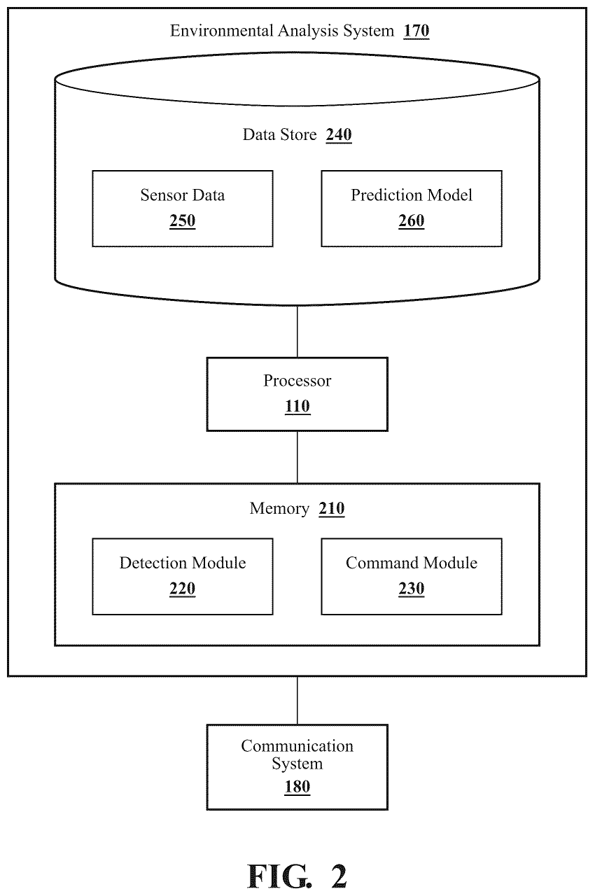

Some of the possible elements of vehicle 100 are shown in FIG. 1 and will be described along with subsequent figures. However, a description of many of the elements in FIG. 1 will be provided after the discussion of FIGS. 2-6 for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. Those of skill in the art, however, will understand that the embodiments described herein may be practiced using various combinations of these elements. In either case, vehicle 100 includes a vehicular environmental analysis system 170 that is implemented to perform methods and other functions as disclosed herein relating to cooperative wildlife monitoring and reducing wildlife risks to vehicles or vice versa. As will be discussed in greater detail subsequently, vehicular environmental analysis system 170, in various embodiments, is implemented partially within vehicle 100 and as a cloud-based service. For example, in one approach, functionality associated with at least one module of vehicular environmental analysis system 170 is implemented within vehicle 100 while further functionality is implemented within a cloud-based computing system.

With reference to FIG. 2, one embodiment of vehicular environmental analysis system 170 of FIG. 1 is further illustrated. Vehicular environmental analysis system 170 is shown as including processor(s) 110 from vehicle 100 of FIG. 1. Accordingly, processor(s) 110 may be a part of vehicular environmental analysis system 170, vehicular environmental analysis system 170 may include a separate processor from processor 110(s) of vehicle 100, or vehicular environmental analysis system 170 may access processor 110(s) through a data bus or another communication path. In one embodiment, vehicular environmental analysis system 170 includes memory 210, which stores detection module 220 and command module 230. Memory 210 is a random-access memory (RAM), read-only memory (ROM), a hard-disk drive, a flash memory, or other suitable memory for storing detection module 220 and command module 230. Detection module 220 and command module 230 are, for example, computer-readable instructions that when executed by processor(s) 110 cause processor(s) 110 to perform the various functions disclosed herein.

Vehicular environmental analysis system 170 as illustrated in FIG. 2 is generally an abstracted form of vehicular environmental analysis system 170 as may be implemented between vehicle 100 and a cloud-computing environment. Accordingly, vehicular environmental analysis system 170 may be embodied at least in part within a cloud-computing environment to perform the methods described herein.

With reference to FIG. 2, detection module 220 generally includes instructions that function to control processor(s) 110 to receive data inputs from one or more sensors of vehicle 100. The inputs are, in one embodiment, observations of one or more objects in an environment proximate to vehicle 100, other aspects about the surroundings, or both. As provided for herein, detection module 220, in one embodiment, acquires sensor data 250 that includes at least camera images. In further arrangements, detection module 220 acquires sensor data 250 from further sensors such as radar 123, LiDAR 124, and other sensors as may be suitable for identifying vehicles, locations of the vehicles, lane markers, crosswalks, traffic signs, vehicle parking areas, road surface types, curbs, vehicle barriers, and so on. In one embodiment, detection module 220 may also acquire sensor data 250 from one or more sensors that allows for the detection of wildlife objects. For example, wildlife objects may be comprised of any sensor data 250 that may be relevant to the determination of animal presence or behavior, such as observations of animals through visual or audio sensors, detection of food, cover, or habitat, or other factors as described herein.

Accordingly, detection module 220, in one embodiment, controls the respective sensors to provide sensor data 250. Additionally, while detection module 220 is discussed as controlling the various sensors to provide sensor data 250, in one or more embodiments, detection module 220 may employ other techniques to acquire sensor data 250 that are either active or passive. For example, detection module 220 may passively sniff sensor data 250 from a stream of electronic information provided by the various sensors to further components within vehicle 100. Moreover, detection module 220 may undertake various approaches to fuse data from multiple sensors when providing sensor data 250, from sensor data acquired over a wireless communication link (e.g., v2v) from one or more of the surrounding vehicles, or from a combination thereof. Thus, sensor data 250, in one embodiment, represents a combination of perceptions acquired from multiple sensors.

In addition to locations of surrounding vehicles, sensor data 250 may also include, for example, odometry information, GPS data, or other location data. Moreover, detection module 220, in one embodiment, controls the sensors to acquire sensor data about an area that encompasses 360 degrees about vehicle 100, which may then be stored in sensor data 250. In some embodiments, such area sensor data may be used to provide a comprehensive assessment of the surrounding environment around vehicle 100. Of course, in alternative embodiments, detection module 220 may acquire the sensor data about a forward direction alone when, for example, vehicle 100 is not equipped with further sensors to include additional regions about the vehicle or the additional regions are not scanned due to other reasons (e.g., unnecessary due to known current conditions).

Moreover, in one embodiment, vehicular environmental analysis system 170 includes a database 240. Database 240 is, in one embodiment, an electronic data structure stored in memory 210 or another data store and that is configured with routines that may be executed by processor(s) 110 for analyzing stored data, providing stored data, organizing stored data, and so on. Thus, in one embodiment, database 240 stores data used by the detection module 220 and command module 230 in executing various functions. In one embodiment, database 240 includes sensor data 250 along with, for example, metadata that characterize various aspects of sensor data 250. For example, the metadata may include location coordinates (e.g., longitude and latitude), relative map coordinates or tile identifiers, time/date stamps from when separate sensor data 250 was generated, and so on.

Detection module 220, in one embodiment, is further configured to perform additional tasks beyond controlling the respective sensors to acquire and provide sensor data 250. For example, detection module 220 includes instructions that may cause processor(s) 110 to obtain battery measurements as described herein. In some embodiments, detection module 220 may receive and store battery measurements.

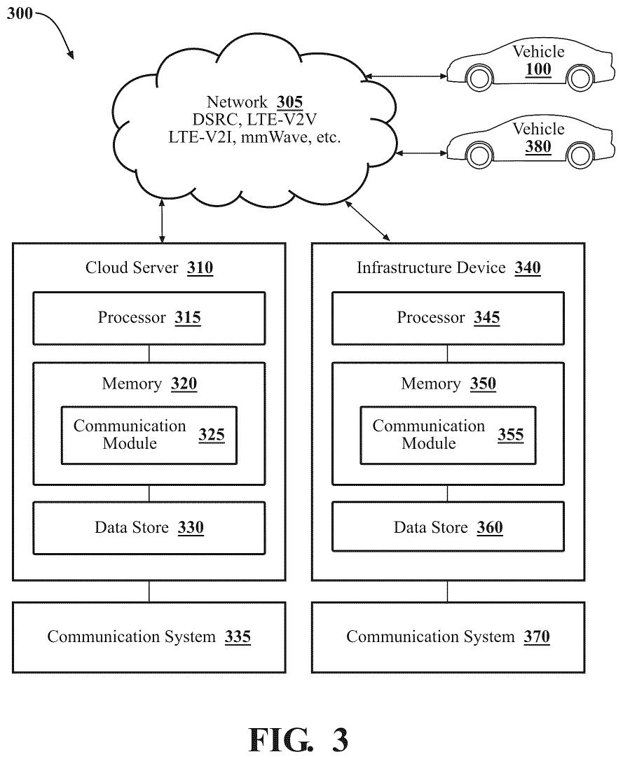

In one embodiment, command module 230 generally includes instructions that function to control the processor(s) 110 or collection of processors in the cloud-computing environment 300 as shown in FIG. 3.

With reference to FIG. 3, vehicle 100 may be connected to a network 305, which allows for communication between vehicle 100 and cloud servers (e.g., cloud server 310), infrastructure devices (e.g., infrastructure device 340), other vehicles (e.g., vehicle 380), and any other systems connected to network 305. With respect to network 305, such a network may use any form of communication or networking to exchange data, including but not limited to the Internet, Directed Short Range Communication (DSRC) service, LTE, 5G, millimeter wave (mmWave) communications, and so on.

Cloud server 310 is shown as including a processor 315 that may be a part of vehicular environmental analysis system 170 through network 305 via communication unit 335. In one embodiment, cloud server 310 includes a memory 320 that stores a communication module 325. Memory 320 is a random-access memory (RAM), read-only memory (ROM), a hard-disk drive, a flash memory, or other suitable memory for storing communication module 325. Communication module 325 is, for example, computer-readable instructions that when executed by processor 315 causes processor 315 to perform the various functions disclosed herein. Moreover, in one embodiment, cloud server 310 includes database 330. Database 330 is, in one embodiment, an electronic data structure stored in a memory 320 or another data store and that is configured with routines that may be executed by processor 315 for analyzing stored data, providing stored data, organizing stored data, and so on.

Infrastructure device 340 is shown as including a processor 345 that may be a part of vehicular environmental analysis system 170 through network 305 via communication unit 370. In one embodiment, infrastructure device 340 includes a memory 350 that stores a communication module 355. Memory 350 is a random-access memory (RAM), read-only memory (ROM), a hard-disk drive, a flash memory, or other suitable memory for storing communication module 355. Communication module 355 is, for example, computer-readable instructions that when executed by processor 345 causes processor 345 to perform the various functions disclosed herein. Moreover, in one embodiment, infrastructure device 340 includes a database 360. Database 360 is, in one embodiment, an electronic data structure stored in memory 350 or another data store and that is configured with routines that may be executed by processor 345 for analyzing stored data, providing stored data, organizing stored data, and so on.

Accordingly, in addition to information obtained from sensor data 250, vehicular environmental analysis system 170 may obtain information from cloud servers (e.g., cloud server 310), infrastructure devices (e.g., infrastructure device 340), other vehicles (e.g., vehicle 380), and any other systems connected to network 305. For example, cloud servers (e.g., cloud server 310) may be used to perform the same tasks as described herein with respect to command module 230.

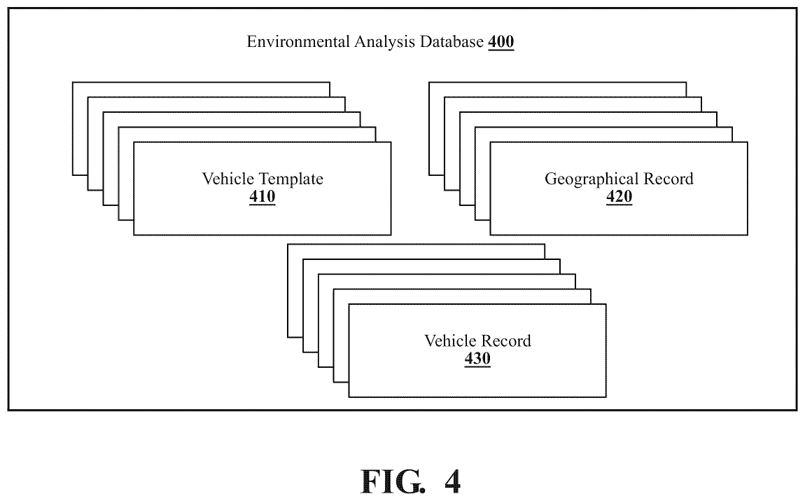

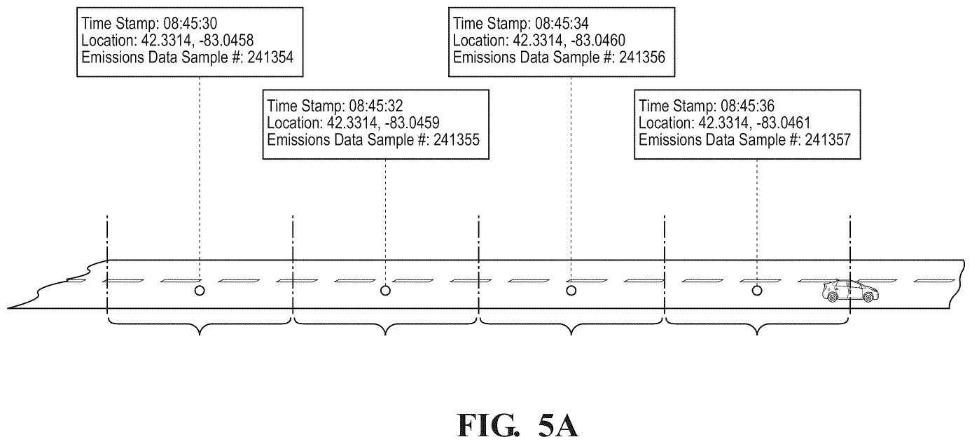

With respect to FIG. 4, an example of an environmental analysis database 400 is shown. Environmental analysis database 400 may be a general repository of environmental related data that resides, for example, within cloud-computing environment 300 or vehicle 100. For any vehicle type, a vehicle template 410 may be used to describe various characteristics of a vehicle type as described below. In addition, for any particular vehicle of interest, a vehicle record 420 may be stored to describe various data regarding a vehicle as described below. In addition, for any location of interest, a geographical record 430 may be generated and stored to describe various environmental characteristics of the location as described below.

Each vehicle template 410 may contain information allowing for the identification of a vehicle type as well as information relating to the configuration of the vehicle type and its environmental impact based on that configuration. For example, a vehicle template for a specific vehicle type may contain visual markers for identifying a vehicle associated with the vehicle type, such as an outline of the vehicle and any distinctive visual characteristics (e.g., vehicle badging, trim details, lighting configuration), paint identifiers (e.g., a specific paint color or pattern may be limited to a specific model year or configuration for a vehicle type), vehicle images, wireframe models, and so on. A vehicle template for a specific vehicle type may also contain audio markers for identifying a vehicle associated with the vehicle type, such as engine sounds, exhaust sounds, electronically generated sounds (e.g., low-speed pedestrian warning sounds). A vehicle template for a specific vehicle type may also contain electronic markers for identifying a vehicle associated with the vehicle type, such as information that may be provided via Vehicle-to-Vehicle communications to describe a vehicle type associated with the vehicle. Vehicle type as used herein may refer to any desired category of vehicles sharing one or more similar characteristics.

With regard to information in a vehicle template relating to the configuration of a vehicle type, such information may include entries describing the make and model of the vehicle, the weight of the vehicle, the engine/transmission set-up of the vehicle, suspension configuration, tire configuration, fuel/battery capacity, fuel/energy efficiency; towing capability; HVAC capability; passenger capacity and so on.

With regard to information in a vehicle template relating to its environmental impact, such information may include entries related to emissions models, algorithms, or other data for estimating the expected environmental impact of the vehicle type. For example, a vehicle template may contain emissions models, algorithms, or other data provided by a manufacturer, a government agency, or by third parties who have evaluated a vehicle's emissions performance, such that emissions-related data regarding the vehicle as described herein may be used to estimate the vehicle's environmental impact.

While some examples herein have described vehicle templates for vehicles associated with a specific vehicle type (e.g., “Toyota Tacoma TRD Off-Road”), in some embodiments a vehicle template may also be used to describe a more general group of vehicles (e.g., compact SUVs, motorcycles). Such an approach may be advantageous where, for example, vehicle templates for specific vehicle types are not available (e.g., a vintage vehicle from the 1970s may be associated with a more generalized vehicle template for a group of vehicles from that era). Such an approach may also be advantageous where it is preferred to provide a general vehicle template if information in a more specific vehicle template is lacking or other deficient. For example, pick-up trucks are often available in a wide variety of configurations, such that information from a more generic vehicle template for that pick-up truck series may be used if a vehicle template for a specific configuration does not possess the desired information. As yet another example, new model year vehicles may arrive with vehicle templates that are only partially complete, such that prior model year vehicle templates may provide an acceptable fallback substitute until the new model year vehicle templates are updated.

Each vehicle record 420 may contain information entries related to the current or prior status of a vehicle, such as odometer readings, fuel/energy levels, fuel/energy efficiencies, current/past locations, current/past routes, engine hours, last oil change, battery health data, estimated tire life, and so on. Vehicle record 420 may also contain entries related to estimates of emissions for the vehicle, which may further include data, models, etc. supporting such estimates. For example, a vehicle over time may provide updates to a vehicle record stored locally that allows for remote monitoring of vehicle emissions when retrieved via a cloud service. As another example, other vehicles may record data from observations of the vehicle (e.g., speed, acceleration), which may then be used to estimate the vehicle's emissions. The data obtained from remote observations, any estimates derived therefrom, or both may then be stored in a vehicle record (e.g., in a remote vehicle, in the cloud).

Geographical record 430 may contain information allowing for the identification of geographic locations or areas and may also contain emissions data relating to such geographic locations or areas. For example, entries relating to geographic area/locations, such as GPS coordinates, property addresses, property records, zoning records, plat map, surveys, geographic information system data, and so on may be stored in a geographical record. A geographical record may also describe how to divide up a geographical location or area, such as how a road system may be broken up into interconnected road segments. As another example, a geographical record may divide up different transit networks into different geographical segments (e.g., light rail segment, busway segment, highway segment).

With respect to the emissions data relating to geographic locations or areas, a geographical record may contain entries describing point source emissions, non-point source emissions, or both associated with such locations or areas. For example, a geographical record may note the emissions being generated by an industrial facility at a specific location. As another example, a geographical record may indicate emissions being generated by agricultural activity in a general area or location. For example, emissions data within a geographical record may apply to multiple geographic locations or areas, such as the smoke from agricultural burning that is impacting multiple road segments. In some embodiments, geographic locations or areas within a geographical record (e.g., road segments) may be adjusted based on the availability of emissions data. For example, if the amount of emissions-related data associated within a road segment increases above a threshold, that road segment may be subdivided.

While examples herein are given with respect to vehicle templates, vehicle records, and geographical records, such records may be merged together, placed within each other, cross-linked, and so on with each other in environmental analysis database 400.

In some embodiments, command module 230 may receive a vehicle template based on sensor data 250. For example, command module 230 may detect visual markers associated with a vehicle type based on camera images (e.g., shape of the vehicle, vehicle badges, lighting configuration), then search for one or more vehicle templates that correlate to such visual markers. Command module 230 may also detect other markers (e.g., audio markers, electronic markers) that may allow the vehicle to search for and obtain a vehicle template. In performing a search, command module 230 may make a request with any desired markers to a cloud server that can then search for one or more vehicle templates that correlate to such markers.

Whether the search is performed locally or via the cloud, command module 230 may then receive one or more vehicle templates. In some embodiments, the one or more vehicle templates may also be received with metrics describing the extent that each vehicle template matches the markers provided during the search. Command module 230 may then select a vehicle template based on such metrics, such as choosing the vehicle template with the highest correlation to the markers provided. In some embodiments, if the metrics don't satisfy a sufficiency condition command module 230 may determine that no vehicle template is a valid match. For example, if a correlation value indicating the likelihood of a match is provided with a vehicle template is below a threshold, command module 230 may determine that it is not a valid match.

If a valid match does not occur, command module 230 may continue to collect markers within sensor data 250 and perform additional searches for a vehicle template until a valid match occurs. In some embodiments, potentially matching vehicle templates may contain information about additional markers that command module 230 may use to evaluate sensor data 250 for such markers. For example, upon receiving a group of vehicle templates, such templates may provide information about visual markers that distinguish between rear-wheel drive and all-wheel drive vehicle types.

In some embodiments, command module 230 may be able to receive a vehicle template based on information such as a license plate number, vehicle identification number, or other unique identifiers.

In some embodiments, command module 230 may receive emissions data based on sensor data 250. For example, camera data may indicate the presence of smoke or fire, exhaust fumes, and so on. As another example, a vehicle may be equipped with sensors that allow for the detection of oxygen, carbon monoxide, nitrogen oxide, particulate matter, hydrocarbons, carbon dioxide, volatile organic compounds, ammonia, and so on. In some embodiments, sensor data 250 may allow for detection of such emissions from another vehicle, such as through data recorded from infrared or ultraviolet absorption sensors, tunable diode laser absorption spectroscopy, ultrasonic sensors, or other remote sensing devices. In some embodiments, command module 230 may rely on information from a vehicle template to adjust emissions data. For example, a vehicle template may denote the absorption of light at specific wavelengths by the vehicle paint used for that vehicle type, such that measurements based on reflection of signals against such a painted surface may be adjusted.

In some embodiments, command module 230 may utilize emissions data from another source to calibrate emissions data in sensor data 250. For example, if a more accurate infrastructure device is recording emissions data (e.g., from the surrounding environment, from vehicles as the pass), command module 230 may compare sensor data 250 with such infrastructure emissions data and perform adjustments as needed to improve the accuracy of emissions data in sensor data 250. For example, emissions data from a more accurate infrastructure device may be used as a ground truth in calibrating machine learning models for estimating or analyzing emissions-related data.

Generally, any emissions-related data relating to a vehicle that may be used to estimate an environmental impact by that vehicle may be recorded by command module 230 in a vehicle record associated with that vehicle. For example, command module 230 may associate emissions-related data with a particular vehicle based on the type of sensor used to obtain the data and the vehicle's proximity to vehicle 100 (e.g., a vehicle directly in front of sensors on vehicle 100 used for measuring exhaust emissions may be associated with that data). In some embodiments, emissions-related data may be associated with multiple vehicles by command module 230, such as those in general proximity to vehicle 100. For example, if the vehicle is operating at the tail of a platoon, emissions-related data may be associated with one or more vehicles ahead of vehicle 100 within the platoon.

In some embodiments, command module 230 may be able to obtain emissions-related data based on the behavior of another vehicle. For example, the speed, acceleration, braking, or other actions by a vehicle may be recorded as emissions-related data in a vehicle record associated with the vehicle. As another example, whether a vehicle is engaged in platooning, following other vehicles (e.g., slipstreaming), has windows open/closed, convertible top up or down, performing towing, etc. may also be recorded as emissions-related data in a vehicle record associated with the vehicle.

In some embodiments, command module 230 may be able to determine emissions related data to be recorded for a vehicle based on a vehicle template associated with a vehicle. For example, a vehicle template may provide models for a vehicle's emissions based on speed, acceleration, and other emissions-related data. As such, the estimates provided by the model from a vehicle template associated with a vehicle may be stored in a vehicle record associated with the vehicle. As another example, a vehicle template may specify emissions-related data of higher or lesser importance for performing environmental impact analysis, such that command module 230 prioritizes capturing more valuable emissions-related data.

In some embodiments, command module 230 may record emissions-related data in a geographical record. For example, command module 230 may record emissions-related data obtained within a road segment as associated with that road segment in a geographical record. In various embodiments, as more data is stored within a geographical record command module 230 may adjust associations of emissions-related data with areas or locations in a geographical record. For example, road segments within a geographical record may be subdivided once the amount of emissions-related data within a road segment satisfy one or more criteria is collected (e.g., more than twenty samples). In some embodiments, command module 230 may also record vehicle-related data associated with the emissions-related data in the geographical record. For example, emissions-related data may indicate one or more vehicle templates or vehicle records that are related to the emissions-related data (e.g., by having been present when such data was recorded).

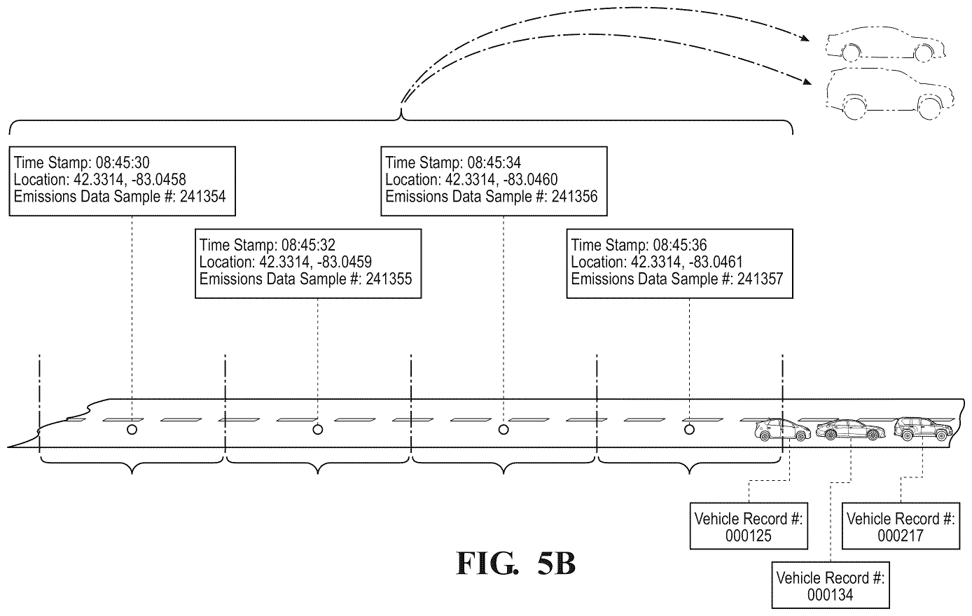

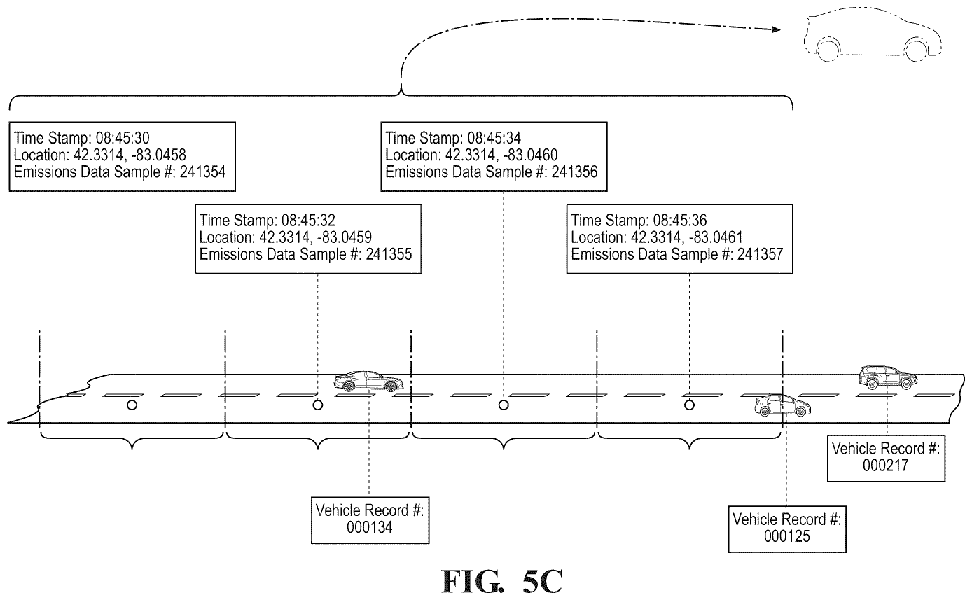

As shown in FIG. 5A-C, examples are shown of how command module 100 may operate in an environment to gather emissions-related data. First, as shown in FIG. 5A as the vehicle traverses through road segments as defined by a geographic record, vehicle 100 may associate a set of emissions-related data with each road segment. Second, as shown in FIG. 5B as vehicle 100 travels in a platoon, it may associate a set of emissions-related data as a whole with vehicles in the platoon (e.g., by recording exhaust emissions to vehicle records of the vehicles in the platoon). Finally, as shown in FIG. 5C as vehicle 100 encounters nearby vehicles, it may observe vehicle actions and perform estimates of their emissions (e.g., by using models from vehicle templates that use speed and acceleration as inputs to output an environmental impact). In this manner, vehicle 100 as it travels along may describe the emissions detected within a specific area at a specific date and time, the vehicles present in that environment, the emissions associated with those vehicles, and so on.

In some embodiments, command module 230 may use machine learning, artificial intelligence, etc. to evaluate emissions-related data in geographical records, vehicle records, or both. For example, it traditionally has been difficult for policy planners to evaluate actual emissions and actual vehicle usage in terms of a series of road segments. As such, it may be difficult for example to determine how policies affecting transportation uses may affect or shift environmental impacts based on actual road usage. Accordingly, command module 230 may allow a policy planner to analyze the actual vehicle types giving rise to emissions in specific areas and determine how attempts to adjust or change such vehicle types may affect such emissions.

For example, command module 230 may perform statistical analysis based on the time and location of emissions-related data across road segments to determine environmental impacts along one or more paths of road segments. Accordingly, command module 230 may be able to provide path dependent environmental impact results for highways, collector roads, residential roads, etc. based on the slices of emissions-related data that has been recorded within road segments. In addition, command module 230 may determine one or more correlations between one or more vehicle types and the environmental impacts indicated by such path dependent emissions-related data based on analysis of vehicle records associated with the path-dependent emissions-related data. For example, where vehicle types such as long-haul tractor-trailers are present, such an analysis of the path-dependent emissions-related data and the vehicle records may demonstrate that tractor-trailers are correlated with an increase in diesel-related environmental impacts along a series of road segments. Once such an analysis has been undertaken, substitute of vehicle types may be simulated (e.g., swapping diesel for electric tractor-trailers) to determine if a desired change in environmental impacts will occur or alternatively result in undesirable consequences (e.g., increased environmental impact due to increased power generation using coal).

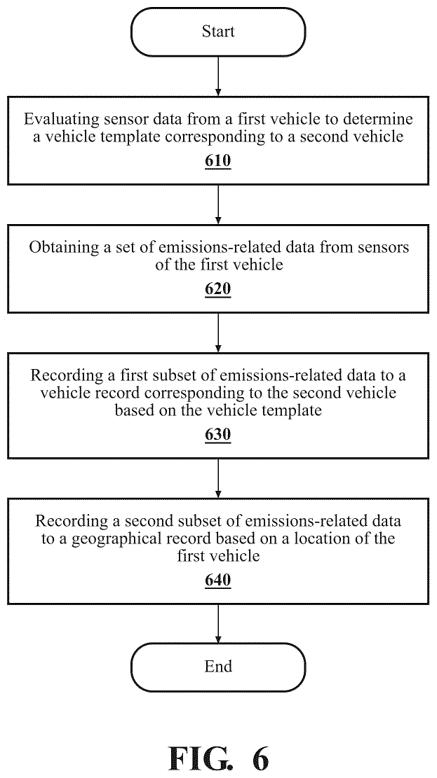

FIG. 6 illustrates a flowchart of a method 600 that is associated with using emissions analysis strategies. Method 600 will be discussed from the perspective of the vehicular environmental analysis system 170 of FIGS. 1 and 2. While method 600 is discussed in combination with the vehicular environmental analysis system 170, it should be appreciated that the method 600 is not limited to being implemented within vehicular environmental analysis system 170 but is instead one example of a system that may implement method 600.

At step 610, command module 230 may evaluate sensor data from a first vehicle to determine a vehicle template corresponding to a second vehicle. For example, command module 230 may identify various markers (e.g., visual, audio, electronic) that allows command module 230 to search for one or more vehicle templates that best match such markers. In some embodiments, vehicle templates may include further information about markers that command module 230 can evaluate to further improve the determination of whether a vehicle fits such vehicle templates. In some embodiments, command module 230 may seek to find a vehicle template for any nearby vehicle that it can detect. In some embodiments, command module 230 may seek to find a vehicle template for only nearby vehicles satisfying a criterion, such as the vehicle being within range of sensors used for collecting emissions data, vehicles participating in platoon, etc. In some embodiments, a vehicle template may be obtained based on uniquely identifying information associated with a vehicle such as a license plate, vehicle identification number, etc.

At step 620, command module 230 may obtain a set of emissions-related data from sensors of the first vehicle. For example, cameras, ultrasonic, lasers, specialized detectors, and so on may be used to detect emissions in front of vehicle 100 (e.g., to capture exhaust emissions) or in the area surrounding vehicle 100. In some embodiments, such sensors may also capture information that can be relied upon indirectly to estimate emissions, such as data that a vehicle template specifies may be used to estimate emissions via models or algorithms within the vehicle template.

At step 630, command module 230 may record a first subset of emissions-related data to a vehicle record corresponding to the second vehicle based on the vehicle template. For example, a vehicle template may specific emissions model that based on speed, acceleration, braking, or other observable factors allow for an estimate of emissions by such a vehicle type. As another example, a vehicle template may specify a range of emissions (e.g., 1.9 ppm˜6.2 ppm) that such a vehicle type will contribute as it operates. After associating emissions-related data with a vehicle, command module 230 may record such information to a vehicle record associated with the vehicle, which may include vehicle identifying characteristics obtained from the vehicle template.

At step 640, command module 230 may record a second subset of emissions-related data to a geographical record based on the location of the first vehicle. For example, command module 230 may have received a geographical record indicating various road segments making up a road network. In such a situation, command module 230 may then record emissions-related data corresponding to a road segment as vehicle 100 travels through each one.

FIG. 1 will now be discussed in full detail as an example environment within which the system and methods disclosed herein may operate. In some instances, vehicle 100 is configured to switch selectively between various modes, such as an autonomous mode, one or more semi-autonomous operational modes, a manual mode, etc. Such switching may be implemented in a suitable manner, now known, or later developed. “Manual mode” means that all of or a majority of the navigation/maneuvering of the vehicle is performed according to inputs received from a user (e.g., human driver). In one or more arrangements, vehicle 100 may be a conventional vehicle that is configured to operate in only a manual mode.

In one or more embodiments, vehicle 100 is an autonomous vehicle. As used herein, “autonomous vehicle” refers to a vehicle that operates in an autonomous mode. “Autonomous mode” refers to using one or more computing systems to control vehicle 100, such as providing navigation/maneuvering of vehicle 100 along a travel route, with minimal or no input from a human driver. In one or more embodiments, vehicle 100 is either highly automated or completely automated. In one embodiment, vehicle 100 is configured with one or more semi-autonomous operational modes in which one or more computing systems perform a portion of the navigation/maneuvering of the vehicle along a travel route, and a vehicle operator (i.e., driver) provides inputs to the vehicle to perform a portion of the navigation/maneuvering of vehicle 100 along a travel route.

Vehicle 100 may include one or more processors 110. In one or more arrangements, processor(s) 110 may be a main processor of vehicle 100. For instance, processor(s) 110 may be an electronic control unit (ECU). Vehicle 100 may include one or more data stores 115 for storing one or more types of data. Data store(s) 115 may include volatile memory, non-volatile memory, or both. Examples of suitable data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. Data store(s) 115 may be a component of processor(s) 110, or data store 115 may be operatively connected to processor(s) 110 for use thereby. The term “operatively connected,” as used throughout this description, may include direct or indirect connections, including connections without direct physical contact.

In one or more arrangements, data store(s) 115 may include map data 116. Map data 116 may include maps of one or more geographic areas. In some instances, map data 116 may include information or data on roads, traffic control devices, road markings, structures, features, landmarks, or any combination thereof in the one or more geographic areas. Map data 116 may be in any suitable form. In some instances, map data 116 may include aerial views of an area. In some instances, map data 116 may include ground views of an area, including 360-degree ground views. Map data 116 may include measurements, dimensions, distances, information, or any combination thereof for one or more items included in map data 116. Map data 116 may also include measurements, dimensions, distances, information, or any combination thereof relative to other items included in map data 116. Map data 116 may include a digital map with information about road geometry. Map data 116 may be high quality, highly detailed, or both.

In one or more arrangements, map data 116 may include one or more terrain maps 117. Terrain map(s) 117 may include information about the ground, terrain, roads, surfaces, other features, or any combination thereof of one or more geographic areas. Terrain map(s) 117 may include elevation data in the one or more geographic areas. Terrain map(s) 117 may be high quality, highly detailed, or both. Terrain map(s) 117 may define one or more ground surfaces, which may include paved roads, unpaved roads, land, and other things that define a ground surface.

In one or more arrangements, map data 116 may include one or more static obstacle maps 118. Static obstacle map(s) 118 may include information about one or more static obstacles located within one or more geographic areas. A “static obstacle” is a physical object whose position does not change or substantially change over a period of time and whose size does not change or substantially change over a period of time. Examples of static obstacles include trees, buildings, curbs, fences, railings, medians, utility poles, statues, monuments, signs, benches, furniture, mailboxes, large rocks, hills. The static obstacles may be objects that extend above ground level. The one or more static obstacles included in static obstacle map(s) 118 may have location data, size data, dimension data, material data, other data, or any combination thereof, associated with it. Static obstacle map(s) 118 may include measurements, dimensions, distances, information, or any combination thereof for one or more static obstacles. Static obstacle map(s) 118 may be high quality, highly detailed, or both. Static obstacle map(s) 118 may be updated to reflect changes within a mapped area.

Data store(s) 115 may include sensor data 119. In this context, “sensor data” means any information about the sensors that vehicle 100 is equipped with, including the capabilities and other information about such sensors. As will be explained below, vehicle 100 may include sensor system 120. Sensor data 119 may relate to one or more sensors of sensor system 120. As an example, in one or more arrangements, sensor data 119 may include information on one or more LIDAR sensors 124 of sensor system 120.

In some instances, at least a portion of map data 116 or sensor data 119 may be located in data stores(s) 115 located onboard vehicle 100. Alternatively, or in addition, at least a portion of map data 116 or sensor data 119 may be located in data stores(s) 115 that are located remotely from vehicle 100.

As noted above, vehicle 100 may include sensor system 120. Sensor system 120 may include one or more sensors. “Sensor” means any device, component, or system that may detect or sense something. The one or more sensors may be configured to sense, detect, or perform both in real-time. As used herein, the term “real-time” means a level of processing responsiveness that a user or system senses as sufficiently immediate for a particular process or determination to be made, or that enables the processor to keep up with some external process.

In arrangements in which sensor system 120 includes a plurality of sensors, the sensors may work independently from each other. Alternatively, two or more of the sensors may work in combination with each other. In such an embodiment, the two or more sensors may form a sensor network. Sensor system 120, the one or more sensors, or both may be operatively connected to processor(s) 110, data store(s) 115, another element of vehicle 100 (including any of the elements shown in FIG. 1), or any combination thereof. Sensor system 120 may acquire data of at least a portion of the external environment of vehicle 100 (e.g., nearby vehicles).

Sensor system 120 may include any suitable type of sensor. Various examples of different types of sensors will be described herein. However, it will be understood that the embodiments are not limited to the particular sensors described. Sensor system 120 may include one or more vehicle sensors 121. Vehicle sensor(s) 121 may detect, determine, sense, or acquire in a combination thereof information about vehicle 100 itself. In one or more arrangements, vehicle sensor(s) 121 may be configured to detect, sense, or acquire in a combination thereof position and orientation changes of vehicle 100, such as, for example, based on inertial acceleration. In one or more arrangements, vehicle sensor(s) 121 may include one or more accelerometers, one or more gyroscopes, an inertial measurement unit (IMU), a dead-reckoning system, a global navigation satellite system (GNSS), a global positioning system (GPS), a navigation system 147, other suitable sensors, or any combination thereof. Vehicle sensor(s) 121 may be configured to detect, sense, or acquire in a combination thereof one or more characteristics of vehicle 100. In one or more arrangements, vehicle sensor(s) 121 may include a speedometer to determine a current speed of vehicle 100.

Alternatively, or in addition, sensor system 120 may include one or more environment sensors 122 configured to acquire, sense, or acquire in a combination thereof driving environment data. “Driving environment data” includes data or information about the external environment in which an autonomous vehicle is located or one or more portions thereof. For example, environment sensor(s) 122 may be configured to detect, quantify, sense, or acquire in any combination thereof obstacles in at least a portion of the external environment of vehicle 100, information/data about such obstacles, or a combination thereof. Such obstacles may be comprised of stationary objects, dynamic objects, or a combination thereof. Environment sensor(s) 122 may be configured to detect, measure, quantify, sense, or acquire in any combination thereof other things in the external environment of vehicle 100, such as, for example, lane markers, signs, traffic lights, traffic signs, lane lines, crosswalks, curbs proximate to vehicle 100, off-road objects, etc.

Various examples of sensors of sensor system 120 will be described herein. The example sensors may be part of the one or more environment sensor(s) 122, the one or more vehicle sensors 121, or both. However, it will be understood that the embodiments are not limited to the particular sensors described.

As an example, in one or more arrangements, sensor system 120 may include one or more radar sensors 123, one or more LIDAR sensors 124, one or more sonar sensors 125, one or more cameras 126, or any combination thereof. In one or more arrangements, camera(s) 126 may be high dynamic range (HDR) cameras or infrared (IR) cameras.

Vehicle 100 may include an input system 130. An “input system” includes any device, component, system, element or arrangement or groups thereof that enable information/data to be entered into a machine. Input system 130 may receive an input from a vehicle passenger (e.g., a driver or a passenger). Vehicle 100 may include an output system 135. An “output system” includes any device, component, or arrangement or groups thereof that enable information/data to be presented to a vehicle passenger (e.g., a person, a vehicle passenger, etc.).

Vehicle 100 may include one or more vehicle systems 140. Various examples of vehicle system(s) 140 are shown in FIG. 1. However, vehicle 100 may include more, fewer, or different vehicle systems. It should be appreciated that although particular vehicle systems are separately defined, each or any of the systems or portions thereof may be otherwise combined or segregated via hardware, software, or a combination thereof within vehicle 100. Vehicle 100 may include a propulsion system 141, a braking system 142, a steering system 143, throttle system 144, a transmission system 145, a signaling system 146, a navigation system 147, other systems, or any combination thereof. Each of these systems may include one or more devices, components, or combinations thereof, now known or later developed.

Navigation system 147 may include one or more devices, applications, or combinations thereof, now known or later developed, configured to determine the geographic location of the vehicle 100, to determine a travel route for vehicle 100, or to determine both. Navigation system 147 may include one or more mapping applications to determine a travel route for vehicle 100. Navigation system 147 may include a global positioning system, a local positioning system, a geolocation system, or any combination thereof.

Processor(s) 110, vehicular environmental analysis system 170, automated driving module(s) 160, or any combination thereof may be operatively connected to communicate with various aspects of vehicle system(s) 140 or individual components thereof. For example, returning to FIG. 1, processor(s) 110, automated driving module(s) 160, or a combination thereof may be in communication to send or receive information from various aspects of vehicle system(s) 140 to control the movement, speed, maneuvering, heading, direction, etc. of vehicle 100. Processor(s) 110, vehicular environmental analysis system 170, automated driving module(s) 160, or any combination thereof may control some or all of these vehicle system(s) 140 and, thus, may be partially or fully autonomous.

Processor(s) 110, vehicular environmental analysis system 170, automated driving module(s) 160, or any combination thereof may be operable to control at least one of the navigation or maneuvering of vehicle 100 by controlling one or more of vehicle systems 140 or components thereof. For instance, when operating in an autonomous mode, processor(s) 110, vehicular environmental analysis system 170, automated driving module(s) 160, or any combination thereof may control the direction, speed, or both of vehicle 100. Processor(s) 110, vehicular environmental analysis system 170, automated driving module(s) 160, or any combination thereof may cause vehicle 100 to accelerate (e.g., by increasing the supply of fuel provided to the engine), decelerate (e.g., by decreasing the supply of fuel to the engine, by applying brakes), change direction (e.g., by turning the front two wheels), or perform any combination thereof. As used herein, “cause” or “causing” means to make, force, compel, direct, command, instruct, enable, or in any combination thereof an event or action to occur or at least be in a state where such event or action may occur, either in a direct or indirect manner.

Vehicle 100 may include one or more actuators 150. Actuator(s) 150 may be any element or combination of elements operable to modify, adjust, alter, or in any combination thereof one or more of vehicle systems 140 or components thereof to responsive to receiving signals or other inputs from processor(s) 110, automated driving module(s) 160, or a combination thereof. Any suitable actuator may be used. For instance, actuator(s) 150 may include motors, pneumatic actuators, hydraulic pistons, relays, solenoids, and piezoelectric actuators, just to name a few possibilities.

Vehicle 100 may include one or more modules, at least some of which are described herein. The modules may be implemented as computer-readable program code that, when executed by processor(s) 110, implement one or more of the various processes described herein. One or more of the modules may be a component of processor(s) 110, or one or more of the modules may be executed on or distributed among other processing systems to which processor(s) 110 is operatively connected. The modules may include instructions (e.g., program logic) executable by processor(s) 110. Alternatively, or in addition, data store(s) 115 may contain such instructions.

In one or more arrangements, one or more of the modules described herein may include artificial or computational intelligence elements, e.g., neural network, fuzzy logic, or other machine learning algorithms. Further, in one or more arrangements, one or more of the modules may be distributed among a plurality of the modules described herein. In one or more arrangements, two or more of the modules described herein may be combined into a single module.

Vehicle 100 may include one or more autonomous driving modules 160. Automated driving module(s) 160 may be configured to receive data from sensor system 120 or any other type of system capable of capturing information relating to vehicle 100, the external environment of the vehicle 100, or a combination thereof. In one or more arrangements, automated driving module(s) 160 may use such data to generate one or more driving scene models. Automated driving module(s) 160 may determine position and velocity of vehicle 100. Automated driving module(s) 160 may determine the location of obstacles, obstacles, or other environmental features including traffic signs, trees, shrubs, neighboring vehicles, pedestrians, etc.

Automated driving module(s) 160 may be configured to receive, determine, or in a combination thereof location information for obstacles within the external environment of vehicle 100, which may be used by processor(s) 110, one or more of the modules described herein, or any combination thereof to estimate: a position or orientation of vehicle 100; a vehicle position or orientation in global coordinates based on signals from a plurality of satellites or other geolocation systems; or any other data/signals that could be used to determine a position or orientation of vehicle 100 with respect to its environment for use in either creating a map or determining the position of vehicle 100 in respect to map data.

Automated driving module(s) 160 either independently or in combination with vehicular environmental analysis system 170 may be configured to determine travel path(s), current autonomous driving maneuvers for vehicle 100, future autonomous driving maneuvers, modifications to current autonomous driving maneuvers, etc. Such determinations by automated driving module(s) 160 may be based on data acquired by sensor system 120, driving scene models, data from any other suitable source such as determinations from sensor data 250, or any combination thereof. In general, automated driving module(s) 160 may function to implement different levels of automation, including advanced driving assistance (ADAS) functions, semi-autonomous functions, and fully autonomous functions. “Driving maneuver” means one or more actions that affect the movement of a vehicle. Examples of driving maneuvers include accelerating, decelerating, braking, turning, moving in a lateral direction of vehicle 100, changing travel lanes, merging into a travel lane, and reversing, just to name a few possibilities. Automated driving module(s) 160 may be configured to implement driving maneuvers. Automated driving module(s) 160 may cause, directly or indirectly, such autonomous driving maneuvers to be implemented. As used herein, “cause” or “causing” means to make, command, instruct, enable, or in any combination thereof an event or action to occur or at least be in a state where such event or action may occur, either in a direct or indirect manner. Automated driving module(s) 160 may be configured to execute various vehicle functions, whether individually or in combination, to transmit data to, receive data from, interact with, or to control vehicle 100 or one or more systems thereof (e.g., one or more of vehicle systems 140).

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, or processes described above may be realized in hardware or a combination of hardware and software and may be realized in a centralized fashion in one processing system or in a distributed fashion where different elements are spread across several interconnected processing systems. Any kind of processing system or another apparatus adapted for carrying out the methods described herein is suited. A typical combination of hardware and software may be a processing system with computer-usable program code that, when being loaded and executed, controls the processing system such that it carries out the methods described herein. The systems, components, or processes also may be embedded in a computer-readable storage, such as a computer program product or other data programs storage device, readable by a machine, tangibly embodying a program of instructions executable by the machine to perform methods and processes described herein. These elements also may be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that may contain or store a program for use by or in connection with an instruction execution system, apparatus, or device.

Generally, modules as used herein include routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein may be embodied in other forms without departing from the spirit or essential attributes thereof. Accordingly, reference should be made to the following claims, rather than to the foregoing specification, as indicating the scope hereof.

What is claimed is:

1. A system, comprising:
a processor; and
a memory communicably coupled to the processor and storing machine-readable instructions that, when executed by the processor, cause the processor to:
evaluate sensor data from a first vehicle to determine a vehicle template corresponding to a second vehicle;
obtain a set of emissions-related data from sensors of the first vehicle;
record a first subset of emissions-related data to a vehicle record corresponding to the second vehicle based on the vehicle template; and
record a second subset of emissions-related data to a geographical record based on a location of the first vehicle.

2. The system of claim 1, wherein the machine-readable instructions to evaluate sensor data from a first vehicle to determine a vehicle template corresponding to a second vehicle further includes utilizing information obtained from at least one potential vehicle template to improve the determination of the vehicle template.

3. The system of claim 1, wherein the machine-readable instructions further includes causing the processor to record a third subset of emissions-related data to a second vehicle record corresponding to a third vehicle that is travelling in a platoon with the second vehicle.

4. The system of claim 1, wherein the machine-readable instructions to record a first subset of emissions-related data to a vehicle record corresponding to the second vehicle is further based on an additional vehicle template.

5. The system of claim 1, wherein the machine-readable instructions to record a second subset of emissions-related data to a geographical record causes a change in a road segment size.

6. The system of claim 1, wherein the machine-readable instructions further includes to analyze one or more geographical records and one or more vehicle records to estimate vehicle emissions along a path involving multiple road segments.

7. The system of claim 6, wherein the machine-readable instructions further includes to analyze the vehicle emissions along the path involving multiple road segments to evaluate an extent that environmental impacts are dependent on a particular vehicle type.

8. A non-transitory computer-readable medium including instructions that when executed by one or more processors cause the one or more processors to:
evaluate sensor data from a first vehicle to determine a vehicle template corresponding to a second vehicle;
obtain a set of emissions-related data from sensors of the first vehicle;
record a first subset of emissions-related data to a vehicle record corresponding to the second vehicle based on the vehicle template; and
record a second subset of emissions-related data to a geographical record based on a location of the first vehicle.

9. The non-transitory computer-readable medium of claim 8, wherein the instruction to evaluate sensor data from a first vehicle to determine a vehicle template corresponding to a second vehicle further includes utilizing information obtained from at least one potential vehicle template to improve the determination of the vehicle template.

10. The non-transitory computer-readable medium of claim 8, wherein the instruction further includes to record a third subset of emissions-related data to a second vehicle record corresponding to a third vehicle that is travelling in a platoon with the second vehicle.

11. The non-transitory computer-readable medium of claim 8, wherein the instruction to record a first subset of emissions-related data to a vehicle record corresponding to the second vehicle is further based on an additional vehicle template.

12. The non-transitory computer-readable medium of claim 8, wherein the instruction to record a second subset of emissions-related data to a geographical record causes a change in a road segment size.

13. The non-transitory computer-readable medium of claim 8, wherein the instructions further include utilizing one or more geographical records and one or more vehicle records to estimate vehicle emissions along a path involving multiple road segments.

14. A method, comprising:
evaluating sensor data from a first vehicle to determine a vehicle template corresponding to a second vehicle;
obtaining a set of emissions-related data from sensors of the first vehicle;
recording a first subset of emissions-related data to a vehicle record corresponding to the second vehicle based on the vehicle template; and
recording a second subset of emissions-related data to a geographical record based on a location of the first vehicle.

15. The method of claim 14, wherein evaluating sensor data from a first vehicle to determine a vehicle template corresponding to a second vehicle further includes utilizing information obtained from at least one potential vehicle template to improve the determination of the vehicle template.

16. The method of claim 14, further comprising recording a third subset of emissions-related data to a second vehicle record corresponding to a third vehicle that is travelling in a platoon with the second vehicle.

17. The method of claim 14, wherein recording a first subset of emissions-related data to a vehicle record corresponding to the second vehicle is further based on an additional vehicle template.

18. The method of claim 14, wherein recording a second subset of emissions-related data to a geographical record causes a change in a road segment size.

19. The method of claim 14, further comprising:
analyzing one or more geographical records and one or more vehicle records to estimate vehicle emissions along a path involving multiple road segments.

20. The method of claim 19, further comprising:
analyzing the vehicle emissions along the path involving multiple road segments to evaluate an extent that environmental impacts are dependent on a particular vehicle type.
